(19) United States
(12) Patent Application Publication
(10) Pub. No.: US 2007/0299171 A1
(43) Pub. Date: Dec. 27, 2007

(54) Fireproof Composition Based on Thermoplastic Matrix

(76) Inventors: Xavier Couillens, Tournefeuille (FR); Michaelangelo Amorese, Milano (IT)

Correspondence Address: Jean-Luis Seugnet;Rhodia, 8 Cedar Brook Drive, CN 7500, Cranbury, NJ, 08512-7500, US

(21) Appl. No.: 10/583,169

(22) PCT Filed: Dec. 17, 2004
(86) PCT No.: PCT/FR04/03281

§ 371 Date: May 10, 2007

(30) Foreign Application Priority Data
Dec. 19, 2003 (FR) 0314991
Jan. 9, 2004 (FR) 0400180

(51) Int. Cl. C08K 5/5313; C08K 5/3492

(52) U.S. Cl. 524/133

(57) ABSTRACT

The invention relates to a fireproof thermoplastic composition comprising a specific fireproofing system which is based on a phosphinic acid salt and melamine derivatives. The inventive composition is useful, in particular for producing articles used for electric or electronic connections.

The present invention relates to a flame-retarded thermoplastic composition comprising a specific flame-retardant system based on a salt of phosphinic acid and on melamine derivatives. This composition is of use in particular in the preparation of articles employed in the field of electrical or electronic connections.

Compositions based on thermoplastic resins are used in the preparation of articles by various forming processes. These articles are used in numerous technical fields, such as in the preparation of components of electrical or electronic systems. These components have to exhibit good mechanical properties but also properties of chemical resistance and of electrical insulation, as well as good flame retardancy when these components catch fire. One of the important aspects is that these components must not catch fire, that is to say must not produce flames; or else catch fire but at the highest possible temperatures.

The flame retardancy of compositions based on a thermoplastic matrix has been studied for a very long time. Thus, the main flame retardants used are red phosphorus, halogenated compounds, such as polybromodiphenyls, polybromodiphenol ethers, brominated polystyrene, nitrogenous organic compounds belonging to the class of triazines, such as melamine or its derivatives, for example melamine cyanurate and more recently melamine phosphates, polyphosphates and pyrophosphates, or organophosphorous acids and their salts.

There is a constant search for flame-retardant agents having increasingly better flame-retardant properties.

Furthermore, flame retardants, generally used in large amounts, lead to problems in the forming of components. Furthermore, some flame retardants comprising halogens or red phosphorus can generate toxic gases or vapors during the combustion of the polyamide composition. In addition, flame retardants are known to be unstable at high temperatures. Thus, a portion of the flame retardants decomposes during the process for the manufacture of the plastic article, thus reducing their flame-retardant effectiveness.

There thus exists a need for compositions based on a thermoplastic matrix in the preparation of articles having satisfactory mechanical properties and good flame retardancy while avoiding the disadvantages mentioned above.

A first subject matter of the present invention is a composition based on a thermoplastic matrix comprising a flame-retardant system comprising at least:
one compound (F1) of formula (I): 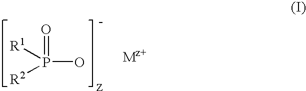
   in which:
   R¹ and R² are identical or different and represent a linear or branched alkyl chain comprising from 1 to 6 carbon atoms, preferably from 1 to 3 carbon atoms, and/or an aryl radical;
   M represents a calcium, magnesium, aluminum and/or zinc ion, preferably a magnesium and/or aluminum ion;
   Z represents 2 or 3, preferably 3;
one compound (F2) which is a reaction product between phosphoric acid and melamine and/or a reaction product between phosphoric acid and a melamine condensation derivative; and
one compound (F3) which is a melamine condensation derivative;
   said composition preferably comprising at least 13% by weight of compounds F1 and F2, more preferably at least 15%, with respect to the total weight of the composition.

The Applicant Company has discovered, entirely surprisingly, that the compounds of this specific flame-retardant system according to the invention act synergistically in the composition based on a thermoplastic matrix and make it possible to obtain articles exhibiting, in addition to a low flame propagation, good mechanical properties and good thermal stability, a high ability not to generate flames when they come into contact with glowing or flame-propagating bodies.

The composition according to the invention can comprise from 1 to 50% by weight of the flame-retardant system according to the invention comprising at least the compounds F1, F2 and F3, preferably from 5 to 40%, more preferably still from 10 to 30%, particularly from 15 to 30%, with respect to the total weight of the composition.

The composition according to the invention can comprise from 1 to 30% by weight of compound F1, preferably from 1 to 20% by weight, more preferably from 5 to 15% by weight.

The composition according to the invention can comprise from 1 to 20% by weight of compound F2, preferably from 2 to 10% by weight.

The composition according to the invention can comprise from 0.1 to 20% by weight of compound F3, preferably from 1 to 10% by weight.

Preferably, the ratio by weight of the compounds F1 and F2 is respectively between 1:1 and 4:1, preferably in the region of 2:1 and 3:2.

R¹ and R² of the compound F1 of formula (I) can be identical or different and can represent a methyl, ethyl, n-propyl, isopropyl, n-butyl, tert-butyl, n-pentyl and/or aryl, such as a phenyl, for example. M is preferably an aluminum ion. The phosphinic acid of the compound F1 can be chosen, for example, from the group consisting of dimethylphosphinic acid, ethylmethylphosphinic acid, diethylphosphinic acid, methyl(n-propyl)phosphinic acid and their mixture. Different phosphinic acids can be used in combination. The compounds F1 are disclosed in particular in patent U.S. Pat. No. 6,255,371.

The phosphinic acid salts according to the invention can be prepared according to the usual methods well known to a person skilled in the art, such as, for example, that disclosed in patent EP 0 699 708. These phosphinic acid salts according to the invention can be used in various forms depending on the nature of the polymer and on the properties desired. For example, in order to obtain good dispersion in the polymer, a phosphinic acid salt can be in the form of fine particles.

The compound F2 is a reaction product between phosphoric acid and melamine and/or a reaction product between phosphoric acid and a melamine condensation derivative. Different compounds F2 can be used in combination. The condensed derivatives of melamine are, for example melam, melem and melon. Use may also be made of compounds which are even more condensed. Preferably, the compound F2 can be chosen, for example, from the group consisting of the following reaction products: melamine polyphosphate, melam polyphosphate, melem polyphosphate and their mixture. It is particularly preferable to use a melamine polyphosphate having chains with a length of greater than 2 and in particular of greater than 10. These compounds are disclosed in particular in patents WO 98/39306 and U.S. Pat. No. 6,255,371. The compounds F2 can also be obtained by processes other than those based on the direct reaction with a phosphoric acid. For example, melamine polyphosphate can be prepared by reaction of melamine with polyphosphoric acid (see WO 98/45364) but also by condensation of melamine phosphate and melamine pyrophosphate (see WO 98/08898).

The compound F3 is a melamine condensation derivative, such as, for example, melam, melem, melon and/or menthone. Use may also be made of compounds which are even more condensed. Different compounds F3 can be used in combination. Use is preferably made of melem, which is a compound of formula C₆H₆N₁₀ which can be represented with the following formula:

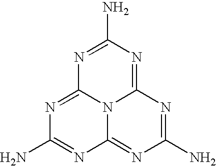

Entirely preferably, the flame-retardant system of the present invention comprises a compound F1 of formula (I) in which R¹=R²=ethyl, M=aluminum and Z=3, a compound F2 which is melamine polyphosphate and a compound F3 which is melem. The ratio by weight of the compounds F1 and F2 can be, for example, respectively 2:1.

The present invention relates to a composition based on a thermoplastic matrix chosen from the group consisting of: (co)polyamides; mono- or diolefin (co)polymers, such as polypropylene, polyisobutylene, polybutylene, polybutadiene, polyethylene; ethylene/propylene copolymers, the optionally grafted styrene copolymer, such as polystyrene, poly(p-methylstyrene), poly(α-methylstyrene); the copolymer of styrene or α-methylstyrene with dienes or with acrylics, such as styrene/butadiene, styrene/acrylonitrile, styrene/maleic anhydride; polyurethanes, polymers comprising halogens, such as polychloropropene, polymers derived from α,β-unsaturated acids, such as polyacrylate, polymethacrylate, polyacrylonitrile, polyacrylamide, unsaturated polymers derived from alcohols and from amines, such as poly(vinyl alcohol), vinyl polymers and their copolymers, such as poly(vinyl acetate), poly(vinyl alcohol), poly(vinyl chloride); polyacetals, such as polyoxymethylene, poly(phenylene oxide)s, poly(phenylene ether)s, poly(phenylene sulfide)s, polyureas, polyketones, polyimides, polyesters, such as poly(ethylene terephthalate), poly(butylene terephthalate), polycarbonates, polyester carbonates, polysulfones, polyether sulfones, their derivatives and their blends.

Mention may be made, for example, of linear semi-crystalline or amorphous polyamides, such as aliphatic polyamides, semiaromatic polyamides and more generally polyamides obtained by polycondensation between a saturated aliphatic or aromatic diacid and a saturated aromatic or aliphatic primary diamine, polyamides obtained by condensation of a lactam and/or of an amino acid, or polyamides obtained by condensation of a mixture of these different monomers. These copolyamides can, for example, be poly(hexamethylene adipamide), polyphthalamides obtained from terephthalic and/or isophthalic acid, copolyamides obtained from caprolactam, and from one or more monomers generally used for the manufacture of polyamides, such as adipic acid, terephthalic acid and/or hexamethylenediamine.

The polyamide is preferably chosen from semicrystalline polyamides, for example the polymers obtained by the polycondensation action of saturated aliphatic dicarboxylic acids having from 6 to 12 carbon atoms, such as, for example, adipic acid, azelaic acid, sebacic acid, dodecanoic acid or a mixture of these, with biprimary diamines, preferably saturated, linear or branched, aliphatic biprimary diamines having from 4 to 12 carbon atoms, such as, for example, hexamethylenediamine, trimethylhexamethylenediamine, tetramethylenediamine, m-xylenediamine or a mixture of these; the polyamides obtained either by direct homopolycondensation of ω-aminoalkanoic acid comprising a hydrocarbon chain having from 4 to 12 carbon atoms or by hydrolytic opening and polymerization of the lactams derived from these acids; the copolyamides obtained from the starting monomers of the abovementioned polyamides, it being possible for the acid component of these copolyamides additionally to consist partially of terephthalic acid and/or of isophthalic acid; and the blends of these polyamides or their copolymers.

Mention will be made, as illustration of the polyamides obtained by polycondensation of diacids and of diamines, for example, of polyamide 4,6 (polymer of tetramethylenediamine and of adipic acid), polyamide 6,6 (polymer of hexamethylenediamine and of adipic acid), polyamide 6,9 (polymer of hexamethylenediamine and of azelaic acid), polyamide 6,10 (polymer of hexamethylenediamine and of sebacic acid), polyamide 6,12 (polymer of hexamethylenediamine and of dodecanedioic acid).

Mention will be made, as illustration of the polyamides obtained by homopolycondensation which may be suitable, of polyamide 4 (polymer of 4-aminobutanoic acid or of γ-butyrolactam), polyamide 5 (polymer of 5-aminopentanoic acid or of δ-amylolactam), polyamide 6 (polymer of ε-caprolactam), polyamide 7 (polymer of 7-aminoheptanoic acid), polyamide 8 (polymer of capryllactam), polyamide 9 (polymer of 9-aminononanoic acid), polyamide 10 (polymer of 10-aminodecanoic acid), polyamide 11 (polymer of 11-aminoundecanoic acid), polyamide 12 (polymer of 12-aminododecanoic acid or of lauryllactam).

Mention will be made, as illustration of the copolyamides, for example, of polyamide 6,6/6,10 (copolymer of hexamethylenediamine, of adipic acid and of sebacic acid), polyamide 6,6/6 (copolymer of hexamethylenediamine, of adipic acid and of caprolactam), polyamide 6/12, polyamide 6/11, polyamide 6/6,36.

Mention may also be made of polyamide 6(T), which is a polyamide obtained by polycondensation of terephthalic acid and of hexamethylenediamine; polyamide 9(T), which is a polyamide obtained by polycondensation of terephthalic acid and of a diamine comprising 9 carbon atoms; polyamide 6(I), which is a polyamide obtained by polycondensation of isophthalic acid and of hexamethylenediamine; and polyamide MXD6, which is a polyamide obtained by polycondensation of adipic acid and of meta-xylylenediamine.

The (co)polyamide matrix according to the invention generally comprises at least one (co)polyamide chosen from the group consisting of (co)polyamide 6; 4; 11; 12, 4.6; 6.6; 6.9; 6.10; 6.12; 6.18; 6.36; 6(T); 9(T); 6(I); MXD6; their copolymers and blends.

The composition according to the invention can also comprise reinforcing fillers well known to a person skilled in the art and chosen, for example, from the group consisting of glass fibers, carbon fibers, inorganic fibers, ceramic fibers, heat-resistant organic fibers, such as polyphthalamide fibers, and inorganic fillers, such as wollastonite, kaolin, clay, silica and mica, and inorganic nanofillers, such as montmorillonite and α-ZrP; and their mixtures. Glass fibers are particularly preferred according to the invention. The glass fibers preferably used are glass fibers for polyamides having, for example, a mean diameter of between 5 and 20 μm, preferably between 10 and 14 μm, such as, for example, the glass fibers CS123D-10C (Owens Corning Fibreglass), CS1103 (Owens Corning Fibreglass) and CS983 (Vetrotex) and CS99B (Vetrotex). The reinforcing fillers can represent from 0 to 80%, preferably from 5 to 55%, more preferably still from 10 to 40% by weight, with respect to the total weight of the composition.

The composition according to invention can also comprise one or more additives commonly used by persons skilled in the art in compositions used for the manufacture of molded articles. Mention may thus be made, as examples of additives, of heat stabilizers, molding agents, such as calcium stearate, UV stabilizers, antioxidants, lubricants, abrasion reducers, pigments, dyes, plasticizers, laser marking promoters or agents which modify the impact strength. By way of examples, the antioxidants and heat stabilizers are, for example, alkaline halides, copper halides, sterically hindered phenolic compounds, organic phosphites and aromatic amines.

In addition, the composition according to the invention can also comprise various other flame-retardant compounds or various other agents which are synergistic with the flame-retardant system, such as heat stabilizers. Mention may be made, for example, of ceramic powder, magnesium hydroxide, hydrotalcites, magnesium carbonates and the other alkaline earth metal carbonates, zinc oxide, zinc stannate, zinc hydroxystannate, zinc phosphate, zinc borate, zinc sulfide, aluminum hydroxide, aluminum phosphate and red phosphorus, nitrogenous organic compounds belonging to the class of the triazines, such as melamine and/or its derivatives, such as melamine cyanurate. The zinc-based compounds, such as zinc borate, can be present in proportions of between 0.01 and 5% by weight, preferably between 0.1 and 5% by weight, with respect to the total weight of the composition.

The present invention also relates to a process for the manufacture of a flame-retarded composition according to the invention in which at least one thermoplastic matrix and at least one flame-retardant system as described above are blended, for example extrusion melt blended or dry blended.

The blending can be carried out in the molten state, for example in a single- or twin-screw extruder, or by blending without conversion to the molten state, for example in a mechanical mixer. The compounds can be produced simultaneously or successively. Any means known to a person skilled in the art relating to the introduction of the various compounds of a thermoplastic composition can be used. Use is generally made of an extrusion device in which the material is heated, subjected to a shear force and conveyed. Such devices are fully known to a person skilled in the art. The composition according to the invention, when it is prepared using an extrusion device, can be put into the form of granules or used directly for the forming of an article.

The present invention also relates to an article obtained by forming a composition according to the invention, in particular by a process chosen from the group consisting of an extrusion process, such as the extrusion of sheets and films, a molding process, such as compression molding, an injection process, such as injection molding, and a spinning process. Such articles can be used in the field of the automobile industry, of electrical or electronic connections, such as components of circuit breakers, switches, connectors or the like.

Other details or advantages of the invention will become more clearly apparent in the light of the examples, given below solely by way of indication.

The compounds used in the examples below are as follows:
PA 66: PA 66 having a viscosity number of 140 ml/g (ISO 307, formic acid) and an Mn of 17 600 g/mol (measured by GPC);
Compound F1 of formula (I) in which R¹=R²=ethyl, M=aluminum and Z=3;
Compound F2: melamine polyphosphate;
Compound F3: melem (2,6,10-triamino-symmetric-heptazine), Delacal® 450 (Delamin);
GF: Glass fibers CS99B (Vetrotex);
CS: Calcium stearate;
ZB: Zinc borate, Firebrake® ZB (US Borax).

### EXAMPLE 1

### Manufacture of Compositions

The compositions are prepared by blending the components, in proportions shown in table 1 of example 2, on a Werner & Pfleiderer ZSK 40 twin-screw extruder, having a screw speed of 200 rpm and an output of 35 kg/h, at a temperature of 270° C. The glass fibers are added to the blend at the throat of the extruder. The granules are dried and melted on an Arburg 320 M500-210 injection molding machine at a temperature of 270-280° C. and subsequently molded at 80-90° C. in the form of test specimens.

The final compositions comprise 30% of glass fibers and 0.5% of calcium stearate.

### EXAMPLE 2

### Measurement of the Properties

The properties are determined on test specimens according to the following methods:

The flame resistance is measured according to the UL 94 test (Underwriters Laboratories). This test is carried out with test specimens with a thickness of 0.8 mm, after conditioning for 48 hours at 50% RH (relative humidity) and 168 hours at 70° C. The result is classified as follows: N.C.: nonclassified (weak flame retardancy). V-2: the mean burning time is less than 25 seconds and the maximum burning time is less than 30 seconds (self extinguishing); polyamide drip igniting the cotton. V-1: the mean burning time is less than 25 seconds and the maximum burning time is less than 30 seconds (self extinguishing); no ignition of the cotton by the drip. V-0: the mean burning time is less than 5 seconds and the maximum burning time is less than 10 seconds (self extinguishing); no ignition of the cotton.
GWFT: The ability to extinguish a flame caused by the application of a glow wire according to standard IEC 60695-2-12 to test specimens with a thickness of 1.0 mm and a surface area of 80×80 mm at a temperature of 960° C. is measured. The composition is recorded as successfully passing the test when there is ignition during the application of the glow wire but self extinguishing within 30 seconds after removal of said glow wire. The composition is recorded as failing the test when there is ignition during the application of the glow wire and no self extinguishing within 30 seconds after removal of said glow wire. The test is successfully passed when three different test specimens successively confirm the same temperature.
GWIT: The ability not to form a flame following the application of a glow wire according to standard IEC 60695-2-13 to test specimens with a thickness of 1.0 mm at a temperature of 750° C. is measured. When the sample successfully passes the test at 750° C., the standard provides for the addition at 25° C. to this temperature and the sample is consequently classified with a GWIT of 775° C. The composition is recorded as successfully passing the test when there is no ignition during the application of the glow wire. The composition is recorded as failing this test when there is ignition during the application of the glow wire, that is to say production of flames lasting more than 5 seconds. The test is successfully passed when three different test specimens successively confirm the same temperature.
Charpy impact strength according to standards ISO 179\1eA and ISO 179\leU.
CTI: According to standard IEC 112. The CTI resistance is the voltage for which a material does not experience flames at its surface. For this test, currents are applied 50 times, this being the case every 30 seconds, at the same point via a saline ammonium chloride solution which drops within a fixed space between two electrodes. If flames do not occur, this being the case up to completion of the 50 applications, the test is successfully passed.

The properties of the compositions produced above are collated in table 1 (the percentages are expressed by weight).

TABLE 1

| | A | 1 | 2 | 3 | 4 |
|---|---|---|---|---|---|
| PA 66 (%) | 51.5 | 46.5 | 50 | 47 | 46.5 |
| F1 (%) | 11.5 | 11.5 | 12.5 | 10 | 12 |
| F2 (%) | 6 | 6 | 6.5 | 5 | 6 |
| F3 (%) | 0 | 5 | 1 | 7 | 5 |
| ZB (%) | 0.5 | 0.5 | 0.5 | 0.5 | 0 |
| GWIT | failure | passes | passes | passes | passes |
| (775° C.) | | | | | |
| GWFT | passes | passes | passes | passes | passes |
| (960° C.) | | | | | |
| UL 94 | V-0 | V-0 | V-0 | V-0 | V-0 |
| Charpy | 59.6 | 49.9 | 53.3 | 49.1 | 56.5 |
| (kJ/m²) | | | | | |
| CTI (volt) | 600 | 600 | 600 | 575 | — |

The compositions according to the invention make it possible to obtain articles having very satisfactory mechanical behavior as well as low flammability and good flame retardancy, in comparison with the articles obtained from compositions of the prior art not comprising melem.

1-14. (canceled)

15. A composition based on a thermoplastic matrix having a flame-retardant system, comprising at least:
one compound (F1) of formula (I): 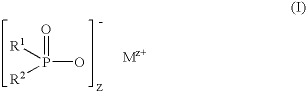
in which:
R¹ and R² are identical or different and represent a linear or branched alkyl chain comprising from 1 to 6 carbon atoms and/or an aryl radical; M represents a calcium, magnesium, aluminum or zinc ion; Z represents 2 or 3;
one compound (F2) which is a reaction product between phosphoric acid and melamine and/or a reaction product between phosphoric acid and a melamine condensation derivative; and
one compound (F3) which is a melamine condensation derivative;
said composition comprising at least 13% by weight of compounds F1 and F2, preferably at least 15%, with respect to the total weight of the composition.

16. The composition as claimed in claim 15, comprising from 1 to 50% by weight of the flame-retardant system comprising at least the compounds F1, F2 and F3, with respect to the total weight of the composition.

17. The composition as claimed in claim 15, comprising from 1 to 30% by weight of compound F1.

18. The composition as claimed in claim 15, comprising from 1 to 20% by weight of compound F2.

19. The composition as claimed in claim 15, comprising from 0.1 to 20% by weight of compound F3.

20. The composition as claimed in claim 15, wherein the phosphinic acid of the compound F1 is dimethylphosphinic acid, ethylmethylphosphinic acid, diethylphosphinic acid, or methyl(n-propyl)phosphinic acid.

21. The composition as claimed in claim 15, wherein the compound F2 is melamine polyphosphate, melam polyphosphate, or melem.

22. The composition as claimed in claim 15, wherein the compound F3 is melam, melem, or melon.

23. The composition as claimed in claim 15, wherein the thermoplastic matrix is (co)polyamide; mono- or diolefin (co)polymer, polyurethanes, polymers comprising halogens, polymers derived from α,β-unsaturated acids, unsaturated polymers, vinyl polymers and their copolymers, polyacetals, poly(phenylene ether)s, poly(phenylene sulfide)s, polyureas, polyketones, polyimides, polyesters, polycarbonates, polyester carbonates, polysulfones, or polyether sulfones.

24. The composition as claimed in claim 23, wherein the thermoplastic matrix is polypropylene, polyisobutylene, polybutylene, polybutadiene, polyethylene; polystyrene, poly(p-methylstyrene), poly(α-methylstyrene); styrene/butadiene, styrene/acrylonitrile, styrene/maleic anhydride, polychloropropene, polyacrylate, polymethacrylate, polyacrylonitrile, polyacrylamide, poly(vinyl alcohol), poly(vinyl acetate), poly(vinyl alcohol), poly(vinyl chloride); polyoxymethylene, poly(phenylene oxide)s, poly(ethylene terephthalate), or poly(butylene terephthalate).

25. The composition as claimed in claim 23, wherein the (co)polyamide matrix comprises (co)polyamide 6; 4; 11; 12, 4.6; 6.6; 6.9; 6.10; 6.12; 6.18; 6.36; 6(T); 9(T); 6(I); or MXD6.

26. The composition as claimed in claim 15, further comprising reinforcing fillers which are glass fibers, carbon fibers, inorganic fibers, ceramic fibers, heat-resistant organic fibers; inorganic fillers, inorganic nanofiller.

27. The composition as claimed in claim 26, wherein the reinforcing fillers are wollastonite, kaolin, clay, silica and mica, or montmorillonite and α-Zr phosphate fibers.

28. The composition as claimed in claim 15, further comprising flame-retardant agents or agents which are synergistic with the flame-retardant system.

29. The composition as claimed in claim 15, wherein the flame-retardant agents or agents which are synergistic with the flame-retardant system are ceramic powder, magnesium hydroxide, hydrotalcites, magnesium carbonates, alkaline earth metal carbonates, zinc oxide, zinc stannate, zinc hydroxystannate, zinc phosphate, zinc borate, zinc sulfide, aluminum hydroxide, aluminum phosphate, red phosphorus, melamine, or melamine cyanurate.

30. A process for the manufacture of a composition as defined in claim 15, comprising the step of blending the thermoplastic matrix with the flame-retardant system comprising at least the compounds F1, F2 and F3.

31. An article of manufacture comprising a composition as defined in claim 15.
